(19) United States
(12) Patent Application Publication
(10) Pub. No.: US 2004/0122964 A1
(43) Pub. Date: Jun. 24, 2004

(54) Record transport protocol for data communication in wireless delivery systems

(76) Inventor: Jin Teik Teh, Los Altos, CA (US)

Correspondence Address: SUPREME PATENT SERVICES, POST OFFICE BOX 2339, SARATOGA, CA, 95070, US

(21) Appl. No.: 10/327,287

(22) Filed: Dec. 20, 2002

(51) Int. Cl. G06F 15/16; H04Q 7/20

(52) U.S. Cl. 709/230; 709/246; 455/466

(57) ABSTRACT

A wireless data delivery platform, on which various content/application developers, and service operators can meet the demands of their wireless subscribers, can not be realized without a unified transport protocol to enable inter-changeability of information delivered between different stand-alone applications. The present invention, a record transport protocol, defines the format of the data sent between various parts of the platform, and between the platform and external clients and servers. Application specific data is extracted and packed into the transport data format and is sent via any transport medium, such as, TCP/IP, HTTP, E-Mail, SMS or through modem.

### FIELD OF THE INVENTION

This invention relates to a method for data communication in a wireless delivery system, and more specially to a method for converting various data formats into a unified record format to be transported in a wireless data delivery software platform.

### BACKGROUND OF THE INVENTION

The wireless Internet is heralded as the next wave of the technology revolution, even though the industry is mostly considered still in its infancy. On the access front, WAP protocol was not designed for rich media and highly interactive contents; while Java falls short on its “Write once, run everywhere” promise. Neither appears to be the right approach in the wireless space. On the other hand, multiple operating systems were proposed for the wireless OS, such as, WinPC, Palm, and many others that are forcing software developers with limited resources to make difficult platform choices. The quest for a software platform that is able to deliver rich, interactive, device integrated wireless information and applications is still in progress.

Ideally, such a wireless data delivery system should enable carriers, hardware manufacturers, application and content developers to deliver interactive content and applications to customers. Furthermore, it should provide client-server interactivity to major existing and next generation wireless OS platforms, including PocketPC, SmartPhone, Symbian, Java, PalmOS, BREW, and more. In short, a data delivery software platform aims to make it possible for data and application to be delivered on demand across various devices.

However, as many of the applications available today were initially developed for stand-alone operations, the lack of inter-changeability of information delivered between different applications remains one of the major obstacles to the realization of seamless, integrated software data delivery platform. Among them, the first issue to be addressed, at the core of the aforementioned software platform, is a record transport protocol that defines a unified record format for data delivery.

### SUMMARY OF THE INVENTION

The present invention, a record transport protocol, defines a unified record format of the data sent between various parts of the platform, and between the platform and external clients and servers. Application specific data is extracted and packed into the transport data format and is sent via any transport medium, such as, TCP/IP, HTTP, E-Mail, SMS or through modem.

The present invention provides technology solutions that could be used in a wireless data delivery platform, on which various content/application developers, and service operators can meet the demands of their wireless subscribers. The present invention also aims to leverage effective bandwidth usage of wireless communication standards to deliver an interactive, dynamic, and media-rich user experience.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a wireless data delivery platform utilizing the present invention.

FIG. 2 shows the unified data format of the present invention.

FIG. 3 shows the format of the Application Specific Data Portion in FIG. 2.

FIG. 4 shows an embodiment of the present invention used in sending data for adding two phone devices and replacing an old entry to the service.

### DETAILED DESCRIPTION OF THE INVENTION

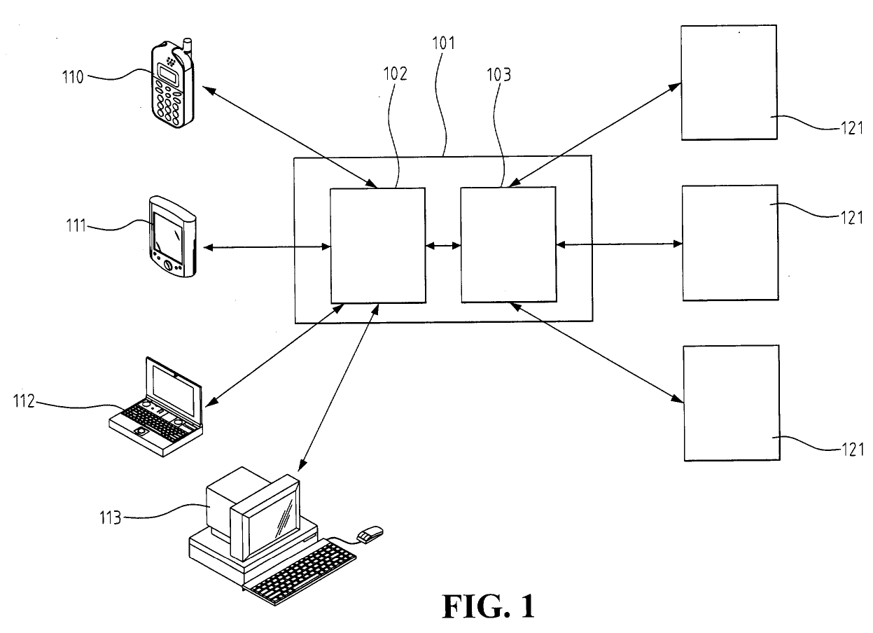

FIG. 1 shows a wireless data delivery software system that the present invention could be used in. The system 101 comprises a platform client 102, and a platform server 103. The platform client 102 is responsible for interfacing with various clients, such as a mobile phone 110, a PDA 111, a notebook computer 112, or a desktop PC 113; and the platform server 103 provides interface to various application servers 121. A unified record format, defined by the present invention, must be complied for the data exchanged between any two parts of the system, including all the exchanges between various clients 110, 111, 112, 113, and the platform client 102, between platform client 102 and platform server 103, and between platform server 103 and various application servers 121.

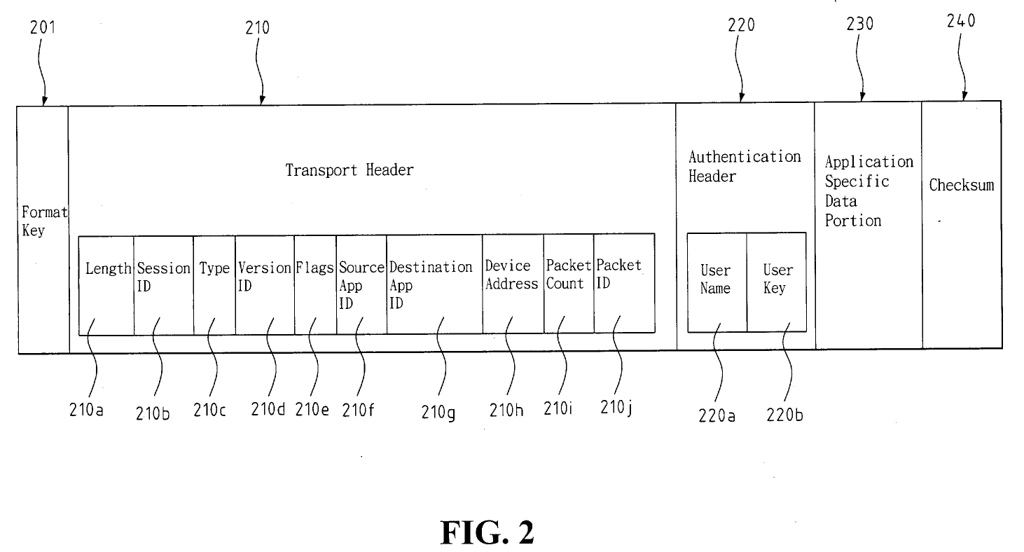

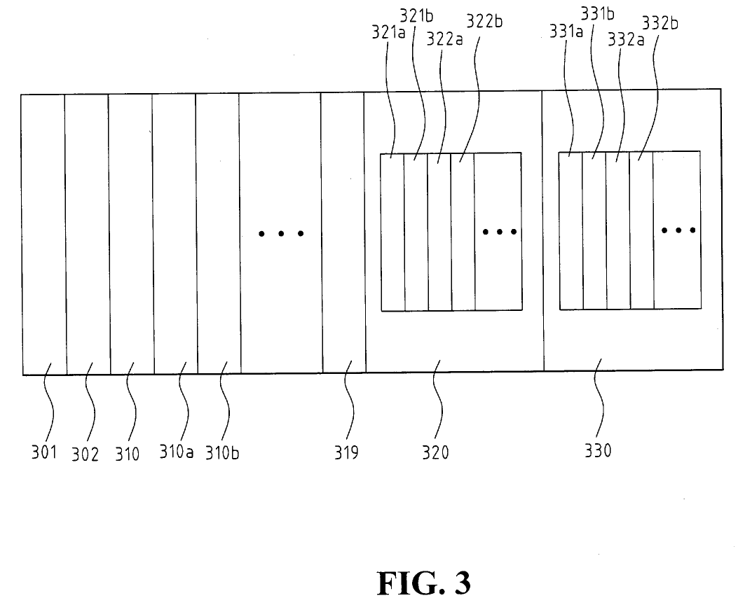

When a wireless client 110, 111, 112, 113 requests for a service from an application, a request message is sent from the client to application server 121. The platform client 102, upon receiving the request message, converts said request message into a unified record format, shown in FIG. 2, and would be described in further details later. During the conversion, the application specific data is extracted from the request message, and packed into the Application Specific data Portion (230 shown in FIG. 2, and further details in FIG. 3). The record, containing the converted request message, is sent to the platform server 103, then forwarded to targeted application server 121, where the request is processed, and a result message is sent back to the requesting client 110, 111, 112, 113. The platform server 103, upon receiving the result message, converts the said message into the same said unified record format. Similarly, during the conversion, the application specific data is extracted from the result message, and packed into the Application Specific data Portion (230 shown in FIG. 2, and further details in FIG. 3). The record, which now contains the converted result message, is forwarded to the platform client 102, then delivered to said requesting client 110, 111, 112, 113.

The unified record format comprises a Format Key 201, a Transport Header 210, an Authentication Header 220, an Application Specific Data Portion 230, and a Checksum 240. A Format Key 201, preceding every message, is to identify the platform on which the message is being delivered. The Transport Header 210, which starts a message, is further comprising the following fields: a Length field 210a, a Session ID field 210b, a Type field 210c, a Version ID field 210d, a Flags field 210e, a Source Application ID field 210f, a Destination Application ID field 210g, a Device Address field 210h, a Packet Count field 210i, a Packet ID field 210j.

The value of the Length field 210a indicates the amount of data in bytes that follows the Length field 210a. The Session ID field 210b contains a number that identifies a unique interaction session between a client (110, 111, 112, or 113, shown in FIG. 1) and a server (121 shown in FIG. 1). The Type field 210c provides additional information about the Application Specific Data Portion 230. The Version ID field 210d indicates the version of this format. The Flags field 210e contains flags that are used to determine the data type, or indicate the message transmission type, either one-way, which requires no response, or two-way, requiring a response. The Source Application ID field 210f contains the ID of the application that originated the message, and the Destination Application ID field 210g contains the ID of the application to receive the message, such as stock client, stock server. The Device Address field 210h contains the device address, such as its phone number or IP address. The Packet ID field 210i contains a number that determines the order of this packet within a group of packets to which this message belongs to make up a complete message, while the Packet Count field 210j provides the total number of packets in this session.

Authentication Header 220 consists of the User Name field 220a and the User Key field 220b. The User Name field 220a identifies the account of the owner of the recipient device, such as, a cell-phone, a PDA or a wireless device; and the User Key field 220b contains an encrypted string known only to the owner of the account. Both fields are included in all messages except when an external server 121 sends a broadcast type message destined to multiple users, or when the platform server 103 sends a message to an external server 121 that does not use the user account.

The Application Specific Data Portion 230 contains data that is specific for each application. Its size equals to the value in the Length field 210a minus lengths of Transport Header 210, Authentication Header 220, and the Checksum 240. The details of this portion is described in FIG. 3. The Checksum field 240, provided at the end of each message, contains a CRC-32 checksum of the entire data message, excluding the Checksum field 240 itself. This is to ensure that the entire message was received correctly. If the checksum does not match, or if the message was truncated, the data message would be discarded or an error returned. It a client does not have the processing power to calculate the checksum, the checksum value is set to a fixed value, for example, 0x484D484D (“HMHM”).

FIG. 3 shows the data format of the Application Specific Data Portion 230 in FIG. 2. Its format must be understood by the platform so that certain filtering or transforming processes performed within the platform could take place. It comprises the following fields: an Action Count field 301, indicating the number of actions described in this message; an Action ID field 302, determined by the source and destination application, whose value is not universally unique between applications, but only unique within the scope of the application server and the application clients; a Field Count field 310, which gives the total number of fields sent in each record, followed by a list of Field ID 310a, 310b, and so on; a Record Count field 319 indicating the number of records in this message, followed by a list of records 320, 330. Each record 320, 330 is further comprising a number of Length-Data field pairs. As shown in FIG. 3, a record 320 contains a Length field 321a and a Data field 321b pair, and a Length field 322a and a Data field 322b pair, and so on. The Length field indicates the amount of data in the following Data field; while the Data field contains the actual data.

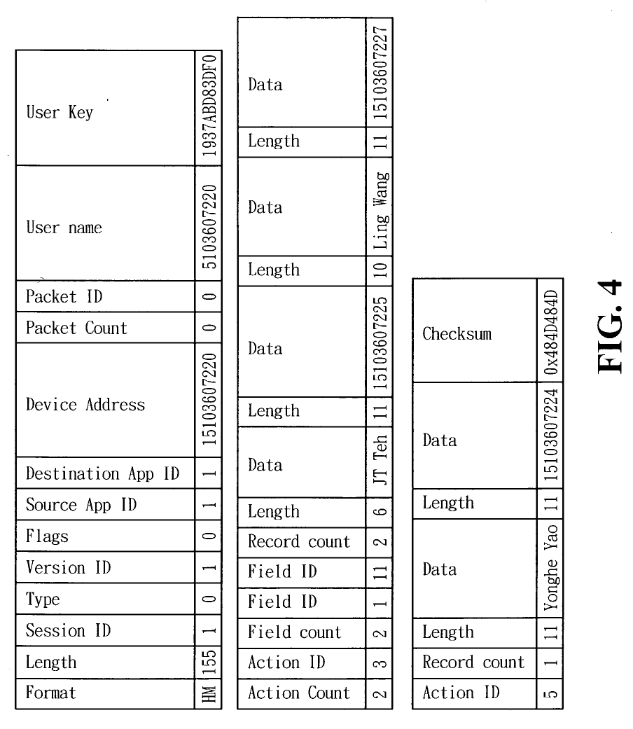

FIG. 4 shows an embodiment of the present invention when a client sends a data message to the server to add two phone book entries, and to replace one phone book entry in a phone book synchronization application. The fields sent are the display name and the cell phone number. In this example, the value contained in the User Key field is not an actual generated key.

While we have shown and described the embodiment in accordance with the present invention, it should be clear to those skilled in the art that further embodiments may be made without departing from the scope of the present invention.

What is claimed is:

1. In a wireless data delivery software system serving a plurality of types of wireless devices and a plurality of type of application servers, a record transport protocol for delivering request and result messages between said devices and said application servers, said record transport protocol comprising:
converting a request message from said wireless devices into a unified record format, and delivering said request message to said application server; and
converting a result message from said application servers into a unified record format, and delivering said result message to said wireless device.

2. A record transport protocol claimed as in claim 1, wherein converting request messages further comprising:
extracting application specific data from said request message sent by said wireless devices; and
packing said extracted application specific data into a unified record format;

3. A record transport protocol claimed as in claim 1, wherein converting result messages further comprising:
extracting application specific data from said result message sent by said application servers; and
packing said extracted application specific data into a unified record format.

4. A unified record format as in claim 1, further comprising:
a Format Key, to identify said platform on which the message being delivered;
a Transport Header;
an Authentication Header;
an Application Specific Data Portion; and
a Checksum.

5. A unified record format claimed as in claim 4, wherein said Transport Header further comprising:
a Length field, indicating the amount of data in bytes following said Length field;
a Session ID field, containing a number for identifying a unique interaction session between a client and a server;
a Type field, providing information about said Application Specific Data Portion;
a Version ID field, specifying the version of said format;
a Flags field;
a Source Application ID field, containing the ID of the application originating said message;
a Destination Application ID field, containing the ID of the application receiving said message;
a Device Address field, containing the device address;
a Packet Count field, containing a number determining the order of said packet within a group of packets making up a complete message; and
a Packet ID field, providing the total number of packets in this session.

6. The Transport Header claimed as in claim 5, wherein said Flags field containing flags used for determining data type.

7. The Transport Header claimed as in claim 5, wherein said Flags field containing flags used for indicating said message transmission type, either one-way, which requires no response, or two-way, requiring a response.

8. The Transport Header claimed as in claim 5, wherein said Device Address field is a phone number.

9. The Transport Header claimed as in claim 5, wherein said Device Address field is an IP address.

10. A unified record format claimed as in claim 4, wherein said Authentication Header comprising a User Name field to identify the account of the recipient device, and a User Key field containing an encrypted string.

11. A unified record format claimed as in claim 4, wherein said Application Specific Data Portion being further comprising:
an Action Count field, indicating the number of actions described in said message;
an Action ID field, whose value being determined by the source and destination application, and unique within the scope of the application server and the application clients;
a Field Count field, indicating the total number of fields sent in each record;
a list of Field ID;
a Record Count field indicating the number of records in said message;
a list of records, each further comprising a plurality of Length-Data field pairs, wherein said Length field indicating the amount of data in said Data field, and said Data field contains the actual data.

12. A unified record format claimed as in claim 4, wherein said Checksum field contains a CRC-32 checksum of entire said data message, excluding said Checksum field itself.

13. A unified record format claimed as in claim 4, wherein a default Checksum is provided when a client is unable to calculate said checksum value.

14. In a wireless data delivery software system serving a plurality of types of wireless devices and a plurality of type of application servers, a record transport protocol for delivering request and result messages between said devices and said application servers, said record transport protocol comprising:
a unified record format, further comprising:
a Format Key, to identify said platform on which the message being delivered;
a Length field, indicating the amount of data in bytes following said Length field;
a Session ID field, containing a number for identifying a unique interaction session between a client and a server;
a Type field, providing information about said Application Specific Data Portion;
a Version ID field, specifying the version of said format;
a Flags field;
a Source Application ID field, containing the ID of the application originating said message;
a Destination Application ID field, containing the ID of the application receiving said message;
a Device Address field, containing the device address;
a Packet Count field, containing a number determining the order of said packet within a group of packets making up a complete message; and
a Packet ID field, providing the total number of packets in this session;
an Authentication Header;
an Action Count field, indicating the number of actions described in said message;
an Action ID field, whose value being determined by the source and destination application, and unique within the scope of the application server and the application clients;
a Field Count field, indicating the total number of fields sent in each record;
a list of Field ID;
a Record Count field indicating the number of records in said message;
a list of records, each further comprising a plurality of Length-Data field pairs, wherein said Length field indicating the amount of data in said Data field, and said Data field contains the actual data; and
a Checksum.
converting a request message from said wireless devices into a unified record format, and delivering said request message to said application server;
converting a result message from said application servers into a unified record format, and delivering said result message to said wireless device.

15. A record transport protocol claimed as in claim 14, wherein converting request messages further comprising:
extracting application specific data from said request message sent by said wireless devices;
packing said extracted application specific data into said unified record format;

16. A record transport protocol claimed as in claim 14, wherein converting result messages further comprising:
extracting application specific data from said result message sent by said plication servers;
packing said extracted application specific data into said unified record format.

17. A wireless data delivery software system serving a plurality of types of wireless devices and a plurality of type of application servers, utilizing a record transport protocol for delivering request and result messages between said devices and said application servers, comprising:
a platform client, interfacing and providing data delivery service to said wireless devices; and
a platform server, interfacing and providing data delivery service to said application servers.
